(19) United States
(12) Patent Application Publication
(10) Pub. No.: US 2013/0091482 A1
(43) Pub. Date: Apr. 11, 2013

(54) METHOD AND APPARATUS FOR DESIGN SPACE EXPLORATION ACCELERATION

(71) Applicant: Benjamin Schafer Carrion, Tokyo (JP)

(72) Inventor: Benjamin Schafer Carrion, Tokyo (JP)

(73) Assignee: NEC CORPORATION, Minato-ku, Tokyo (JP)

(21) Appl. No.: 13/639,187

(22) PCT Filed: Apr. 9, 2010
(86) PCT No.: PCT/JP2010/056792

§ 371 Date: Oct. 16, 2012

(51) Int. Cl. G06F 17/50

(52) U.S. Cl. CPC G06F 17/5045
USPC 716/132

(57) ABSTRACT

A method for accelerating design space exploration of a target device when a behavioral description of the target device is given, includes: parsing the behavioral description to build a dependency parse tree; creating independent sets of clusters based on the dependency parse tree, each cluster being a set of a node or nodes of the dependency parse tree and independently explorable; exploring synthesizable operations of each cluster exhaustively in order to establish impact of each operation synthesized differently on a final circuit in designing of the target device; and combining attributes for the clusters to create designs with improved characteristics under constraints.

### TECHNICAL FIELD

The present invention relates to electronic design automation (EDA) for semiconductor devices such as ICs (integrated circuits), LSIs (large-scale integrations) and VLSIs (very-large-scale integrations), and more particularly to a method and apparatus for accelerating design space exploration.

### RELATED ART

A method and apparatus for accelerating the automatic generation of LSI circuits with the same functionality but different characteristics (e.g., area, latency, throughput, power consumption, memory usage) starting from a behavioral circuit description., also called design space exploration (DSE), is presented. A series of unique hardware architectures with the same functionality that meet a set of constraints (e.g., area, timing, power, temperature) are automatically generated starting from an LSI circuit description at behavioral functional level. The main objective in design space exploration is to find the most efficient circuits for a set of specified constraints. These most efficient designs build what is called the efficient frontier (also called Pareto frontier). FIG. 1 illustrates an example of results of design space exploration in which area and latency are used as the constraints. Each point corresponds to an LSI design with unique area and timing characteristics, points indicated by filled circles corresponding to Pareto optimal LSI designs while points indicated by open circled corresponding to non-Pareto optimal LSI designs. The points of the Pareto optimal LSI designs are arranged on the Pareto frontier.

For simplicity, only two constraints are shown in FIG. 1, but other constraints such as power, temperature, frequency, and so on can also be considered. The architectural tradeoffs can easily be explored within this set, i.e., the designs on the Pareto frontier, rather than considering the entire design space, which is irrelevant to the designer.

The main problem in design space exploration is the size of the design space. Since almost an unlimited number of LSI circuits can be generated from a behavioral circuit description, a brute force search will eventually find all the efficient designs; although this is impractical for larger circuits due to the extremely long runtime taken to generate a single circuit. Therefore, several methods for accelerating the exploration of the design space have been proposed to obtain the most efficient designs as fast as possible.

For example, Benjamin Carrion Schafer et al. [NPL1] proposed to accelerate the design space exploration by applying a fixed set of synthesis directives to predefined set of clusters. This proposed method is fast, but leads to not finding many of the efficient LSI designs.

In [PL1], disclosed is a method for performing a physical design optimization by generating a dataflow from a behavioral description and constraints to generate behavioral synthesis information, forming clusters at the LSI floor-plan level based on the behavioral synthesis information, and re-synthesizing only those clusters that violates timing constraints. The proposed method speeds up the creation of LSI floor-plans that meet the timing constraints.

In addition, [PL2] discloses an LSI design system which can estimate a chip size and critical paths at an early design stage. In this system, a delay model and area model is generated from an LSI description at HDL (hardware description language) level, and a floor-plan is then created based on the area model. A static timing analysis based on the delay model and the floor-plan is carried out to estimate the chip size and critical paths. In [PL3], disclosed is a system which describes a desired electronic circuit model of an LSI with a high level description language and performs a further accurate cost estimation of the LSI. The system first performs a syntax analysis of a description file describing a desired electronic circuit model to generate a control data flow graph having a predetermined graph structure such as a tree structure. Then the system divides the control data flow graph into threads composed of a set of a plurality of connected nodes and achieving a particular function, and optimizing the divided threads to meet with a predetermined area restriction and a predetermined timing restriction, to obtain specifying information of the number, the function, the placement and routing of logic cells for the desired electronic circuit model.

### SUMMARY OF THE INVENTION

Although some acceleration methods of the design space exploration have been proposed, the proposed methods are not enough to rapidly determine the optimal design and the design space exploration is extremely time consuming. There is a demand for accelerating the exploration of the design space in order to obtain the most efficient designs as fast as possible.

Therefore, an exemplary object of the present invention is to provide a method for accelerating the design space search for LSI designs starting from a behavioral description to the most efficient LSI designs faster than the brute force or manual methods.

Another exemplary object of the present invention is to provide a design space exploration apparatus which can perform, in an accelerated manner, the design space search for LSI designs starting from a behavioral description to the most efficient LSI designs faster than the brute force or manual methods.

According to an exemplary aspect of the present invention, a method for accelerating design space exploration of a target device when a behavioral description of the target device is given, includes: parsing the behavioral description to build a dependency parse tree; creating independent sets of clusters based on the dependency parse tree, each cluster being a set of a node or nodes of the dependency parse tree and independently explorable; exploring synthesizable operations of each cluster exhaustively in order to establish impact of each operation synthesized differently on a final circuit in designing of the target device; and combining attributes for the clusters to create designs with improved characteristics under constraints.

According to another exemplary aspect of the present invention, an apparatus of exploring design space of a target device, includes: a first storage storing a behavioral description of the target device; a parse generator parsing the behavioral description read out from the first storage to build a dependency parse tree and creating independent sets of clusters based on the dependency parse tree, each cluster being a set of a node or nodes of the dependency parse tree and independently explorable; a second storage storing constraints and a library of attributes; a preprocessor instrumenting the behavioral description by inserting synthesis directives for each cluster with reference to the library stored in a second storage; a high level synthesizer exploring synthesizable operations of each cluster exhaustively in order to establish impact of each operation synthesized differently on a final circuit in designing of the target device, and combining attributes for the clusters to create designs with improved characteristics under the constraints.

The method and apparatus described herein provide a tool to accelerate the design space exploration of LSI designs.

The above and other objects, features, and advantages of the present invention will become apparent from the following description based on the accompanying drawings which illustrate exemplary embodiments of the present invention.

### BRIEF DESCRIPTION OF THE DRAWINGS

FIG. 1 is a graph illustrating an exemplary design space exploration result showing an efficient LSI design frontier which contains all the Pareto optimal LSI designs;

FIG. 2 is a flow chart illustrating the LSI design exploration method according to an embodiment;

FIG. 3 is a view of an example of screenshot of the design exploration result;

FIG. 4 is a dataflow graph illustrating the entire exploration flow in accordance with an exemplary embodiment;

FIG. 5 is a view illustrating an example of a dependency parse tree generation from a given untimed behavioral LSI design description;

FIG. 6 is a view illustrating construction of independent clusters that will be explored separately in order to analyze the impact on the synthesis directives on the synthesized LSI circuit;

FIG. 7 is a view illustrating an example of behavioral LSI description and the result of the parsed dependency tree and cluster generation;

FIG. 8 is a view illustrating the result of the exploration of the individual clusters for the example given in FIG. 7 by showing an example of the created data structure for each cluster;

FIG. 9 is a view illustrating an example of the final step of the exploration in which new designs with the combination of attributes of each cluster are generated based on the result of the individual cluster exploration;

FIG. 10 is a block diagram illustrating a design space exploration apparatus according to an exemplary embodiment; and

FIG. 11 is a block diagram illustrating an information processing apparatus.

### DESCRIPTION OF EXEMPLARY EMBODIMENTS

Turning now descriptively to the drawings, in which similar reference characters denote similar elements throughout the several views, the attached figures illustrate exemplary embodiments of the present invention which relate to the method and apparatus to accelerate the automated design space exploration of LSI systems specified in a behavioral language, and more particularly to accelerate the search of Pareto optimal designs starting from an untimed high level language description for high level synthesis.

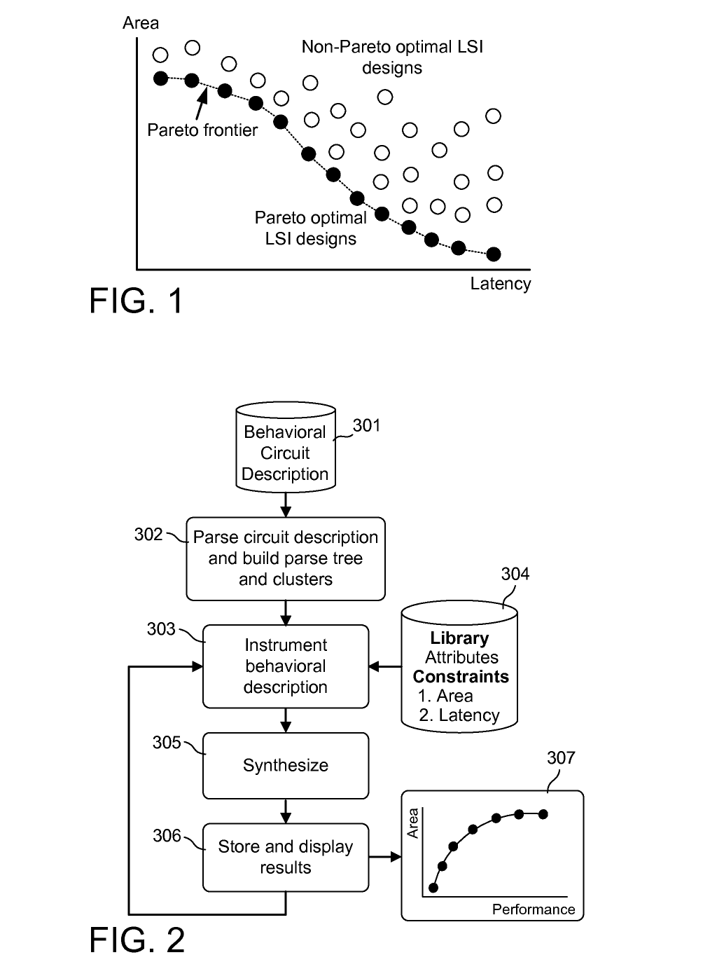

As described above, FIG. 1 shows the general objective of the design space exploration. Only Pareto optimal LSI designs need to be found in order to explore the architectural tradeoffs easily within the set of designs on the Pareto frontier rather than considering the entire design space, which would be impractical and irrelevant to the designer. Obtaining only these LSI designs is very time consuming and not practical using a brute force method or generating these manually.

Outline of the design flow of the LSI design exploration method in an exemplary embodiment is illustrated in FIG. 2. In contrast to the design flow of the related art, which involves manual modification of the LSI description or a very time consuming automated process, the exemplary embodiment accelerates the design space exploration.

The design flow shown in FIG. 2 starts from receiving behavioral LSI functionality description 301. Behavioral description is described by any behavioral or hardware description language such as C language or SystemC language. The description is then parsed and a parse tree and independent clusters with only the operations that can be explored is created in step 302. Next in step 303, the behavioral description is automatically instrumented by inserting synthesis directives directly at the source code for each cluster. Storage unit 304 stores: the library including attributes; and constraints such as area and latency. The attributes stored in storage unit 304 are used to instrument the behavioral description.

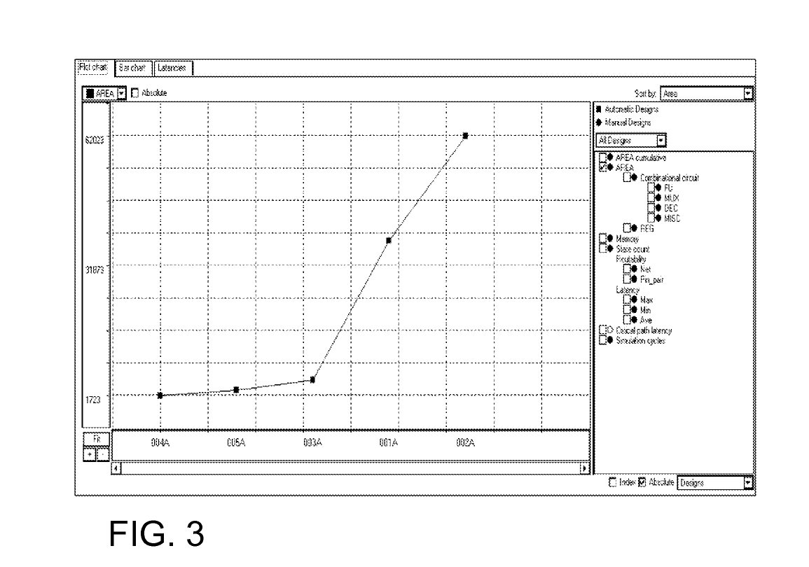

The instrumented behavioral LSI description is then synthesized using a high level synthesis (HLS) tool in step 305, and the results of the synthesis are read and stored in step 306 in order to continue the exploration until all most efficient designs under the constrains stored in storage unit 304 are created. During the iterations, the created designs can be displayed in a trade-off window 307 on a display as shown in FIG. 3. FIG. 3 shows a exemplary screenshot of the circuit exploration results, where each point on the graph corresponds to a circuit with unique characteristics.

As described above, the design space exploration involves the synthesis of the behavioral description using a high level synthesis tool. The synthesis result can be controlled by setting global synthesis options and/or particular synthesis directives annotated directly at the circuit description. These global synthesis options and local synthesis directives lead to the generation of different LSI designs. The global synthesis options affect the entire LSI description, while the local synthesis directives affect only parts of the design and are specified directly at concrete operations in the source code. Some of these operations include “for loops,” functions and arrays. For example, a loop can be unrolled completely, partially or not unrolled. Arrays can be mapped to registers, hardwired logic or a memory, and functions can be synthesized as a single hardware block or multiple blocks. FIG. 1 shows an example of the result of applying different global synthesis options and local synthesis directives to the behavioral description of an LSI design. The figure indicates that designs with larger area tend to have a higher performance, while smaller designs tend to have a lower performance.

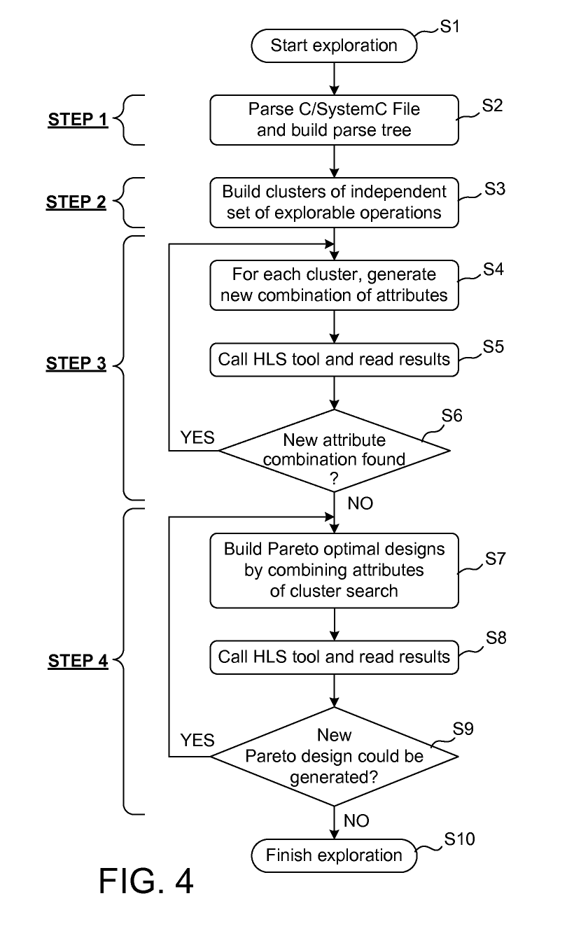

The method according to the present exemplary embodiment will be described in detail. This method is based on a divide-and-conquer technique by inserting synthesis directives to specific operation in the original behavioral LSI description and then performing high level synthesis for the instrumented LSI description. The method generally includes four main steps (i.e., STEP 1 to STEP 4) and two main loops as shown in FIG. 4, one loops contained in STEP 3 while the other loop contained in STEP 4.

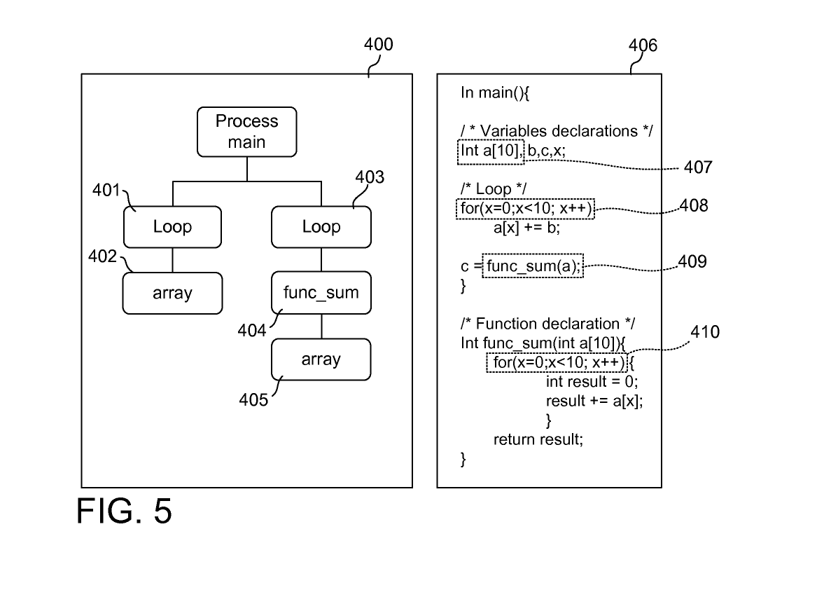

STEP 1: After staring the exploration flow at step S1, the behavioral LSI description is parsed and a dependency parse tree is built for all explorable operations, i.e., operations that can be explored, in step S2. The behavioral description is described by, for example, C language or SystemC language. The explorable operations are operations to which a synthesis directive can be applied. FIG. 5 shows an example of the parse tree generation, where a tree with the dependencies of all the explorable operations specified in an internal or external library is created. The detailed of the creation of the parse tree is described in PCT/JP2009/057043, the disclosure of which is incorporated herein in its entirety by reference.

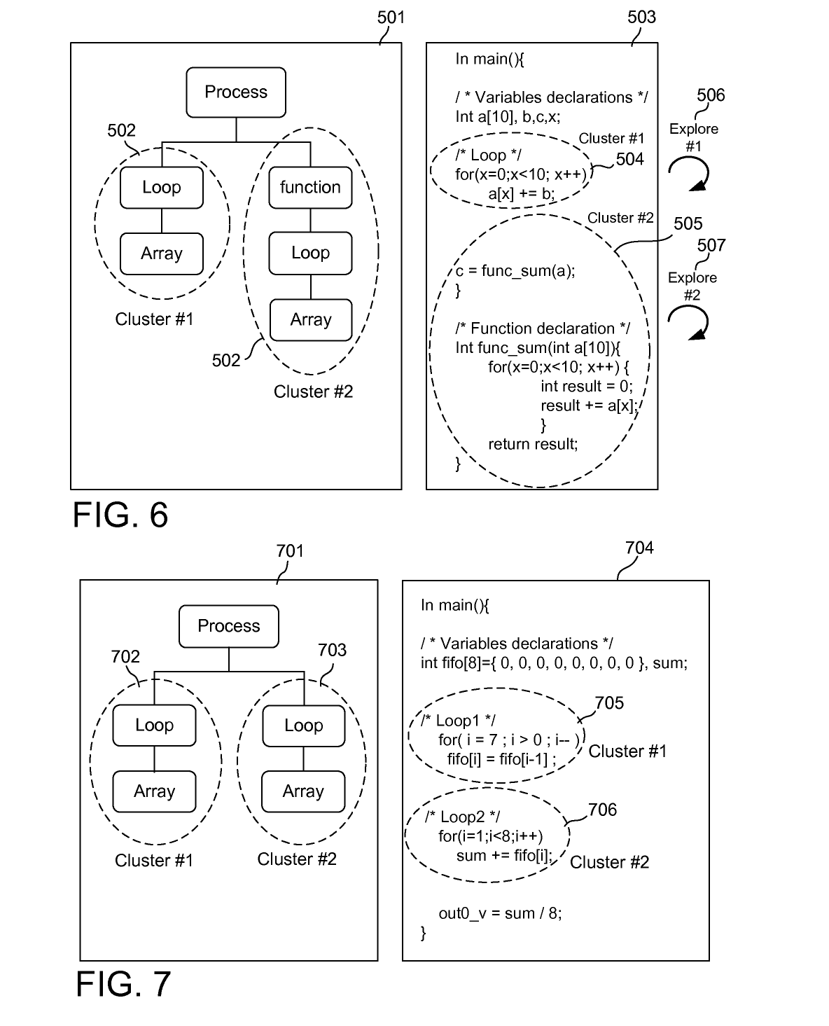

STEP 2: Independent clusters are built for each independent parse tree nodes in step S3. FIG. 6 shows an example of cluster generation.

STEP 3: All of the combinations of synthesis directives (i.e., synthesis attributes) or a significant subset of the combinations are generated for each of the clusters independently in step S4. Each cluster is explored separately. For each combination of synthesis attributes, the newly instrumented behavioral description is synthesized by calling the HLS tool and the synthesis result is read back in order to analyze the impact of each attribute combination on the resultant LSI design (e.g., area, latency, power, temperature), in step S5. Any search algorithm can be used at this step for this purpose. For example, the brute force, simulated annealer, genetic algorithm, but no limited to these. During this step only the attributes of single clusters are explored independently. While exploring one cluster, the explorable operations of the rest of the clusters are left un-instrumented. In order to instrument all the combination, it is checked whether new attribute combination is found or not, at step S6. If exploration for all combinations or the most important combinations has not been completed, the method re-iterates this process of steps S3 and S4.

STEP 4: Once all the clusters have been searched independently, new instrumented LSI descriptions are generated by combining the attributes for all clusters simultaneously. Attributes that lead to more efficient circuits are combined in order to create only the most efficient designs. In particular, each set of attribute of each cluster that will lead to a Pareto optimal LSI designs is identified in step S7, and these optimal designs are combined to generate only Pareto optimal designs by synthesizing each newly instrumented description in step S8. In order to continue the process of steps S7 and S8 until no more Pareto optimal designs are found, it is determined whether a new Pareto design could be generated or not in step S9. If so, the process goes back to step S7 otherwise exits at step S10.

In the present exemplary embodiment, a given behavioral description of an LSI design can be manually instrumented with synthesis directives to, e.g., synthesize arrays as a register or memory of fixed logic. These synthesis directives guide the HLS tool in the synthesis process, converting the behavioral LSI description into a detailed LSI design description such as a RTL (register transfer level) language description. The method of the present embodiment automatically inserts different synthesis directives into the behavioral LSI description thereby resulting in different circuits with different characteristics and keeping only the most efficient designs.

It should be noted that the exploration of each cluster in STEP 3 is completely independent and this method can be partitioned and executed on multiple processors to further accelerate the exploration process. The exploration should ideally run on as many processors as independent clusters. This would accelerate the exploration process by a factor N, where N equals to the number of clusters.

Therefore, in case that multiple processors are available, it is preferable to map exploration processes of respective independent clusters to multiple processors while variably adjust the number of the processors needed based on the number of the clusters. In such a case, the data structure may be re-generated and the partial results may be moved from the different processors to a central processor when each processor finishes the exploration of the cluster assigned thereto.

Next, generation of the dependency parse tree from the original behavioral LSI description in step 302 of FIG. 2 will be described in detail. FIG. 5 illustrates an example of the dependency parse tree which is main data structure of the method of the current exemplary embodiment as it allows extracting independent group of operations of the behavioral description in order to study the effect of synthesis attributes on each of these groups. The dependency parse tree is generated also in STEP 1 of FIG. 4 and the generation process of the parse tree described here is also applicable to the example shown in FIG. 4.

In FIG. 5, each node in dependent parse tree 400 corresponds to an explorable operation in behavioral description 406. In this example, behavioral description 406 includes statement 407 of “int a[10]” which indicates definition of an array. Each time the array defined by statement 407 is accessed, arrays 402 and 405 are included in the parse tree. Similarly, behavioral description 406 includes for-loop statements 408 and 410. In response to for-loop statements 408 and 410, loops 401 and 403 are included in the parse tree, respectively. Statement 409 defines function “func_sum” and this function corresponds to func_sum 404 included in the parse tree.

Next, creation of the clusters in step 302 of FIG. 2 will be explained in detail. FIG. 6 illustrates an example of the generated clusters. Since such a cluster is generated in STEP 2 of FIG. 4, the creation process of the clusters describe here is also applicable to the example shown in FIG. 4.

In FIG. 6, clusters of each independent subset of explorable operations for parse tree 501 are generated from parsed behavioral LSI description 503 which corresponds to un-parsed behavioral LSI description 406 shown in FIG. 5. Two independent clusters are created in this case, where cluster #1 502 includes a loop and array 504 while cluster #2 502 includes a function, loop and the same array 505. Each cluster is explored separately as indicated by reference numerals 506 and 507 using either a brute force method to establish the impact of each attribute combination on the synthesized hardware design or using any heuristic method that can accelerate the design space exploration.

The worst case scenario of this proposed divide-and-conquer method is that the initial untimed high level description only contains one large cluster. In such a case, the exploration runtime is the same as any heuristic methods developed in the related art. The most favorable case is when the source code contains clusters consistent of individual operations. In this case the runtime of the exploration is linear against the number of the operations.

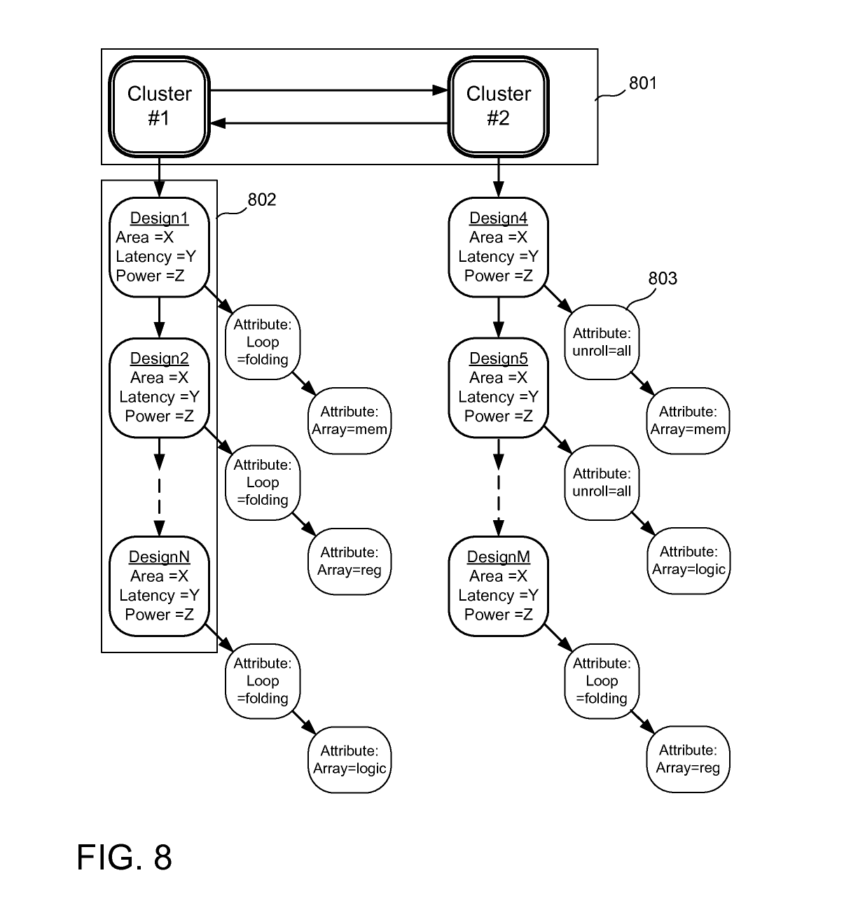

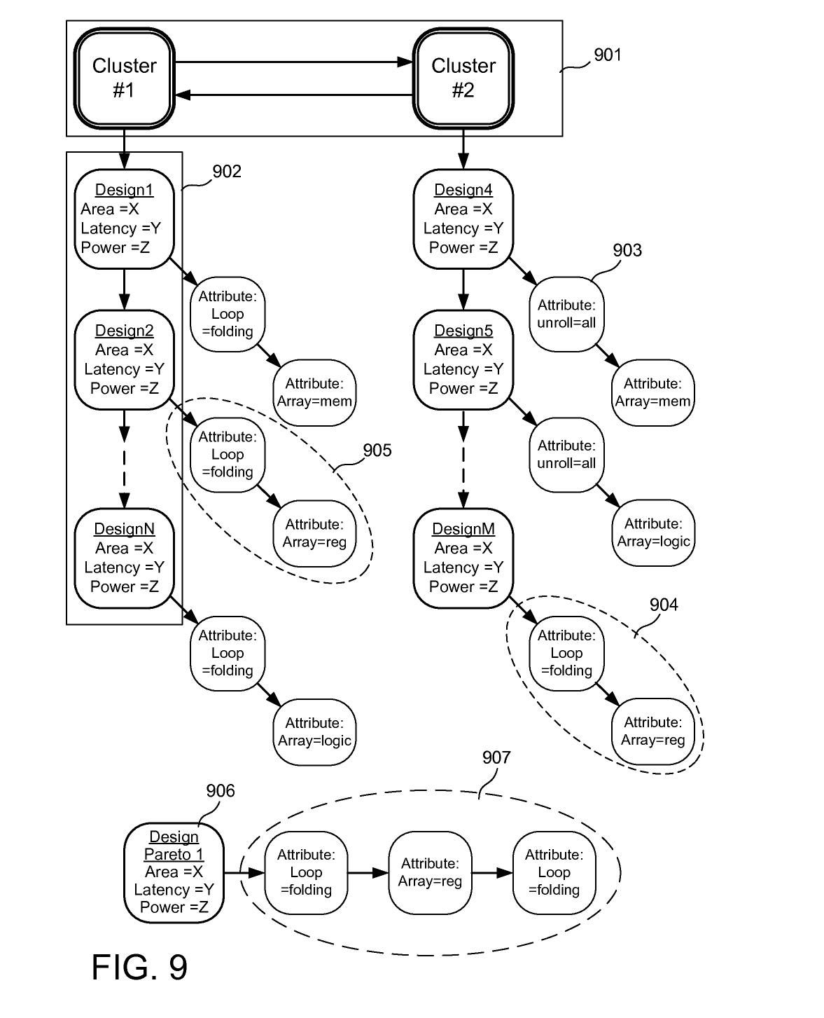

The present exemplary embodiment will now be described in greater detail with reference to FIG. 7, FIG. 8 and FIG. 9 in the context of an example. The problem definition includes one main goal, i.e., the creation of all (or as many as possible) Pareto optimal designs which can minimize the runtime.

FIG. 7 shows an example of a behavioral LSI description and the cluster generated from the behavioral LSI description. The generation of clusters exemplified in FIG. 7 corresponds to STEP 1 and STEP 2 shown in FIG. 4. In FIG. 7, behavioral LSI description 704 reads in eight values into an array and outputs the average of the last eight values. Behavioral LSI description 704 has three explorable operations: two loops (i.e., Loop1 and Loop2) and one array (i.e., fifo[8]). The HLS tool can unroll the loop completely, partially, not unroll, or fold the loop depending on the local synthesis directive specified directly at the source code. In case that no directive is specified, a default behavior programmed into the tool is executed. The array, on the other hand, can be synthesized as registers, or expanded as a memory, whereas in this case the number of ports and some other sub-attributes can be selected.

In FIG. 7, dependency parse tree 701 and the individual clusters are created. In this example, two clusters are generated: cluster #1 (702) and cluster #2 (703) are for the first for-loop (Loop1) and array access indicated by reference numeral 705 and for the second for-loop (Loop2) and array access indicated by reference numeral 706.

FIG. 8 illustrates an example of the created data structure for each cluster as the result of exploration of the individual clusters for the example given in FIG. 7. Such a data structure is created, for example, through STEP 3 shown in FIG. 4 where each combination of attributes is explored for each cluster separately. The result of the synthesis of each design is then read back in order to understand the impact of the attribute combination on the generated circuit.

In FIG. 8, the exploration result is illustrated in the form of an underlined data structure example. The clusters are represented as linked list 801. Each cluster node contains as many designs as unique combination of attributes that are created for each cluster, as shown in design linked list 802. Attribute lists are also represented as sub-linked lists for design linked list 802. Each design node contains information of the results of the synthesis for that particular combination of attributes 803. In the figure, “mem” and “reg” are abbreviations of “memory” and “register,” respectively. The data structure described here allows the study of the effect of each attribute combination on the synthesized design.

FIG. 9 illustrates the final step, i.e., the merging step of the exploration for the example illustrated in FIG. 7, where new designs with the combination of attributes of each cluster are generated based on the result of the individual cluster exploration. This step corresponds to STEP 4 shown in FIG. 4. In the case that clusters have interdependent attributes, only attribute lists which have the same interdependent attribute can be used.

In FIG. 9, each of clusters (i.e., cluster #1 and cluster #2) in cluster list 901 has list 902 of designs each with a unique set of attributes 903. The results of the synthesis of each design are investigated and the combination of attributes 907 that lead to Pareto optimal design 906 is created. In this case, as the array affects both clusters, only those combinations of attributes that have the same attribute for the array can be combined together. The design created from the combination of attributes 905 for cluster #1 and attributes 906 for cluster #2 is synthesized, and then Pareto optimal LSI design 906 is created. The search for Pareto LSI designs is continued until no more new Pareto designs are found.

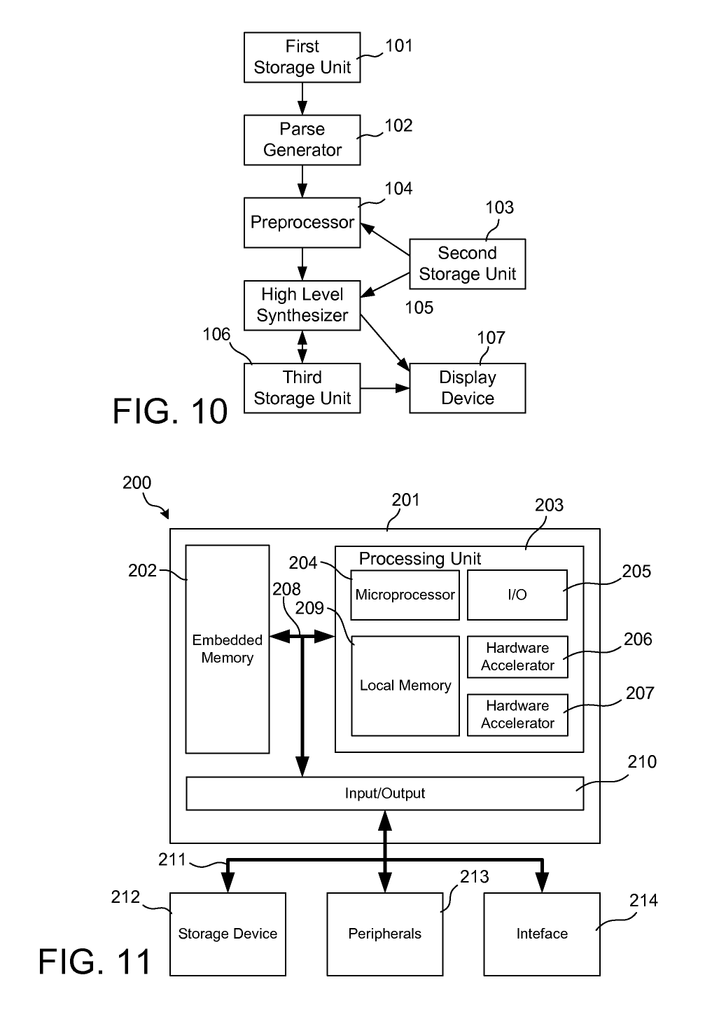

FIG. 10 illustrates configuration of a design space exploration apparatus in which the process of design space exploration of a target device is accelerated by the method described above. The apparatus generally includes: first storage unit 101 storing a behavioral description of the target device; parse generator 102 parsing the behavioral description stored in first storage unit 101 to build a dependency parse tree and creating independent sets of clusters based on the dependency parse tree; second storage unit 103 storing the constraints such as area and latency and storing a library of attributes; preprocessor 104 instrumenting the behavioral description by inserting synthesis directives for each cluster; and high level synthesizer 105 synthesizing the instrumented behavioral description and performing the design space exploration. Here, each cluster is a set of a node or nodes of the dependency parse tree and is independently explorable. In the instrumentation of the behavioral description, preprocessor 104 refers to the library stored in second storage unit 103 and inserts the synthesis directives directly at the source code of the behavioral description.

High level synthesizer 105 may be configured to explore synthesizable operations of each cluster exhaustively in order to establish impact of each operation synthesized differently on a final circuit in designing of the target device, and to combine the attributes for the clusters to create more efficient designs, i.e., designs with improved characteristics under the constraints. High level synthesizer 105 may search for Pareto optimal designs once the high level synthesizer has explored all clusters separately by combining only attribute that will lead to Pareto optimum. In one example, high level synthesizer 105 may be implemented as a high level synthesis (HLS) tool.

The design space exploration apparatus shown in FIG. 10 further includes: third storage unit 106 storing the designs created by high level synthesizer; and display device 107 displaying the created designs as the results of the design space exploration. Display devise 107 displays the results in a manner that distribution of the created designs against the constraints can be recognized. For example, if the constraints used are area and latency, display device 107 displays a graph similar to one shown in FIG. 1. High level synthesizer 105 iteratively reads the results from third storage unit 106 and performs the exploration until all most efficient designs are created.

In some examples, parse generator 102 may generate the independent set of clusters for explorable operations that can be synthesized differently and will therefore impact the final circuit. High level synthesizer 105 may explore each cluster separately by generating combination of attributes for each cluster while not assigning any attribute to rest of the clusters. High level synthesizer 105 may search for Pareto optimal designs once all clusters have been explored separately by combining only attribute that will lead to Pareto optimum.

In the apparatus shown in FIG. 10, if the clusters have interdependencies such as arrays or functions used in multiple clusters, identical attributes of the interdependencies may be used to obtain the Pareto optimal designs. The exploration results may be further refined by refining the exploration for only the Pareto optimal designs. Any optimization options that can disturb the linear behavior of the local attributes performing cross-cluster optimizations, e.g., loop merging, may be disabled. The results of the high level synthesis may be read, and only LSI designs that are the most efficient may be kept with ignoring the non-optimal designs.

Next, an example of the applications of the present exemplary embodiment will be described.

FIG. 11 shows a functional block diagram of an information processing apparatus. Information processing apparatus 200 includes complex processing device 201, which is a subsystem integrated on the same LSI design, including processing unit 203, embedded memory 202, input and output (I/O) port 210. I/O port 210 includes a communication interface. All units in complex processing device 201 are interconnected by inner bus 208. Processing apparatus 203 also includes: storage device 212, and different type of peripherals 213 and interfaces 214. Processing device 201, storage device 212, peripherals 213 and interfaces 214 are interconnected together by bus 211.

Processing unit 203 includes: microprocessor 204, embedded local memory 209, input and output (I/O) port 205 and two dedicated hardware acceleration blocks 206, 207. The acceleration blocks can perform a variety of functions more efficiently than a generic processor, i.e., microprocessor 204. The design of these dedicated acceleration blocks is very time consuming. The method according to the present exemplary embodiment allows the design of the dedicated acceleration blocks faster than the methods of the related art. The present exemplary embodiment can automatically create a set of efficient LSI designs that meet the given area, performance, power and temperature constraints.

Each step constituting the method of the above exemplary embodiments may be also implementable on computer systems. Therefore, the exemplary embodiments may be implemented in a software manner as a computer program for use with a computer system. The computer system may have, for example, a configuration shown in FIG. 11. The program defining the functions of at least one exemplary embodiment can be provided to a computer via a variety of computer-readable media (i.e., signal-bearing medium), which include but are not limited to, (i) information permanently stored on non-writable storage media (e.g., read-only memory devices within a computer such as CD-ROM disks readable by a CD-ROM or DVD drive; (ii) alterable information stored on a writable storage media (e.g., flexible disks within flexible disk drive or hard-disk drive); or (iii) information conveyed to a computer by communications medium, such as through a computer or telephone network, including wireless communication. The latter specifically includes information conveyed via the Internet. Such signal-bearing media, when carrying computer-readable instructions that direct the functions defined by the inventive method, represent alternative exemplary embodiments of the invention. It may also be noted that portions of the program maybe developed and implemented independently, but when combined together constitute further exemplary embodiments of the invention.

Although the above exemplary embodiments are described in the context of LSI circuit design example, the method and apparatus based on the present invention are applicable to many other types of design problems including, for example, design problems relating to digital circuits, scheduling, chemical processing, control systems, neuronal networks, verification and validation methods, regression modeling, identification of unknown systems, communications networks, optical circuits, sensors and so on. The method and apparatus based on the present invention are also applicable to flow network design problems rerating to, for example, road systems, waterways and other large scale physical networks, and applicable to the field of optics, mechanical components, and opto-electrical components, and so on.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The whole or part of the exemplary embodiments disclosed above can be described as, but not limited to, the following supplementary notes:

(Supplementary Note 1) A method for accelerating design space exploration of a target device when a behavioral description of the target device is given, the method comprising:

parsing the behavioral description to build a dependency parse tree;

creating independent sets of clusters based on the dependency parse tree, each cluster being a set of a node or nodes of the dependency parse tree and independently explorable;

exploring synthesizable operations of each cluster exhaustively in order to establish impact of each operation synthesized differently on a final circuit in designing of the target device; and

combining attributes for the clusters to create designs with improved characteristics under constraints.

(Supplementary Note 2) The method according to Supplementary Note 1, wherein the creating includes:

generating the independent set of clusters for explorable operations that can be synthesized differently and will therefore impact the final circuit.

(Supplementary Note 3) The method according to Supplementary Note 1 or 2, wherein the exploring is performed by exploring each cluster separately by generating combination of attributes for each cluster while not assigning any attribute to rest of the clusters.

(Supplementary Note 4) The method according to any one of Supplementary Notes 1 to 3, comprising:

analyzing the impact of each attribute combination on a generated circuit to obtain a partial result; and

storing the partial results to select a final combination of attributes for each operation based on the partial results.

(Supplementary Note 5) The method according to any one of Supplementary Notes 1 to 4, comprising:

searching for Pareto optimal designs once all clusters have been explored separately by combining only attribute that will lead to Pareto optimum.

(Supplementary Note 6) The method according to any one of Supplementary Notes 1 to 4, wherein if the clusters have interdependencies such as arrays or functions used in multiple clusters, identical attributes of the interdependencies are used to obtain the Pareto optimal designs.

(Supplementary Note 7) The method according to any one of Supplementary Notes 1 to 4, comprising:

further refining of the exploration results by refining the exploration for only the Pareto optimal designs.

(Supplementary Note 8) The method according to any one of Supplementary Notes 1 to 7, comprising:

disabling any optimization options that can disturb the linear behavior of the local attributes performing cross-cluster optimizations, e.g., loop merging.

(Supplementary Note 9) The method according to any one of Supplementary Notes 1 to 8, comprising:

reading the results of the high level synthesis, and keeping only LSI designs that are the most efficient while ignoring the non-optimal designs.

(Supplementary Note 10) The method according to any one of Supplementary Notes 1 to 9, further comprising:

mapping exploration processes of respective independent clusters to multiple processors; and

variably adjusting number of the processors needed based on number of the clusters.

(Supplementary Note 11) The method according to Supplementary Note 10, comprising: re-generating data structures; and

moving partial results from the different processors to a central processor when each processor finishes the exploration of the cluster assigned thereto.

(Supplementary Note 12) An apparatus of exploring design space of a target device, comprising:

a first storage storing a behavioral description of the target device;

a parse generator parsing the behavioral description read out from the first storage to build a dependency parse tree and creating independent sets of clusters based on the dependency parse tree, each cluster being a set of a node or nodes of the dependency parse tree and independently explorable;

a second storage storing constraints and a library of attributes;

a preprocessor instrumenting the behavioral description by inserting synthesis directives for each cluster with reference to the library stored in a second storage;

a high level synthesizer exploring synthesizable operations of each cluster exhaustively in order to establish impact of each operation synthesized differently on a final circuit in designing of the target device, and combining attributes for the clusters to create designs with improved characteristics under the constraints.

(Supplementary Note 13) The apparatus according to Supplementary Note 12, wherein the high level synthesizer searches for Pareto optimal designs once the high level synthesizer has explored all clusters separately by combining only attribute that will lead to Pareto optimum.

(Supplementary Note 14) The apparatus according to Supplementary Note 12 or 13, comprising:

a third storage storing the created designs; and

a display device displaying the created designs stored in the third storage in a manner that distribution of the created designs against the constraints can be recognized.

(Supplementary Note 15) The apparatus according to any one of Supplementary Notes 12 to 14, wherein the parse generator generates the independent set of clusters for explorable operations that can be synthesized differently and will therefore impact the final circuit.

(Supplementary Note 16) The apparatus according to any one of Supplementary Notes 12 to 15, wherein the high level synthesizer explores each cluster separately by generating combination of attributes for each cluster while not assigning any attribute to rest of the clusters.

(Supplementary Note 17) The apparatus according to any one of Supplementary Notes 12 to 15, wherein the high level synthesizer searches for Pareto optimal designs once all clusters have been explored separately by combining only attribute that will lead to Pareto optimum.

(Supplementary Note 18) The apparatus according to any one of Supplementary Notes 12 to 15, wherein if the clusters have interdependencies such as arrays or functions used in multiple clusters, identical attributes of the interdependencies are used to obtain the Pareto optimal designs.

(Supplementary Note 19) The apparatus according to any one of Supplementary Notes 12 to 15, wherein the exploration results are further refined by refining the exploration for only the Pareto optimal designs.

(Supplementary Note 20) The apparatus according to any one of Supplementary Notes 12 to 19, wherein any optimization options that can disturb the linear behavior of the local attributes performing cross-cluster optimizations, e.g., loop merging, are disabled.

(Supplementary Note 21) The apparatus according to any one of Supplementary Notes 12 to 20, wherein the results of the high level synthesis are read, and only LSI designs that are the most efficient are kept while the non-optimal designs are ignored.

### CITATION LIST

[PL1] JP-2004-265224-A

[PL2] U.S. Pat. No. 6,463,567

[PL3] US-2002/0162907-A1

[NPL1] “Design Space Exploration Acceleration through Operation Clustering,” Benjamin Carrion Schafer and Kazutoshi Wakabayashi, IEEE Transaction on Computer Aided Design (TCAD), January 2010, Vol. 29, Issue 1, pp. 153-157

1. A method for accelerating design space exploration of a target device when a behavioral description of the target device is given, the method comprising:
parsing the behavioral description to build a dependency parse tree;
creating independent sets of clusters based on the dependency parse tree, each cluster being a set of a node or nodes of the dependency parse tree and independently explorable;
exploring synthesizable operations of each cluster exhaustively in order to establish impact of each operation synthesized differently on a final circuit in designing of the target device; and
combining attributes for the clusters to create designs with improved characteristics under constraints.

2. The method according to claim 1, wherein the creating includes:
generating the independent set of clusters for explorable operations that can be synthesized differently and will therefore impact the final circuit.

3. The method according to claim 1, wherein the exploring is performed by exploring each cluster separately by generating combination of attributes for each cluster while not assigning any attribute to rest of the clusters.

4. The method according to claim 1, comprising:
analyzing the impact of each attribute combination on a generated circuit to obtain a partial result; and
storing the partial results to select a final combination of attributes for each operation based on the partial results.

5. The method according to claim 1, comprising:
searching for Pareto optimal designs once all clusters have been explored separately by combining only attribute that will lead to Pareto optimum.

6. The method according to claim 1, comprising:
further refining of the exploration results by refining the exploration for only the Pareto optimal designs.

7. The method according to claim 1, further comprising:
mapping exploration processes of respective independent clusters to multiple processors; and
variably adjusting number of the processors needed based on number of the clusters.

8. The method according to claim 7, comprising:
re-generating data structures; and
moving partial results from the different processors to a central processor when each processor finishes the exploration of the cluster assigned thereto.

9. An apparatus of exploring design space of a target device, comprising:
a first storage storing a behavioral description of the target device;
a parse generator parsing the behavioral description read out from the first storage to build a dependency parse tree and creating independent sets of clusters based on the dependency parse tree, each cluster being a set of a node or nodes of the dependency parse tree and independently explorable;
a second storage storing constraints and a library of attributes;
a preprocessor instrumenting the behavioral description by inserting synthesis directives for each cluster with reference to the library stored in a second storage;
a high level synthesizer exploring synthesizable operations of each cluster exhaustively in order to establish impact of each operation synthesized differently on a final circuit in designing of the target device, and combining attributes for the clusters to create designs with improved characteristics under the constraints.

10. The apparatus according to claim 9, wherein the high level synthesizer searches for Pareto optimal designs once the high level synthesizer has explored all clusters separately by combining only attribute that will lead to Pareto optimum.
